(19) United States
(12) Patent Application Publication
(10) Pub. No.: US 2015/0324722 A1
(43) Pub. Date: Nov. 12, 2015

(54) METHOD FOR DETERMINING A SAFETY STOCK

(71) Applicant: Caterpillar Inc., Peoria, IL (US)

(72) Inventor: Parthiban Kamalanathan, Chennai (IN)

(73) Assignee: Caterpillar Inc., Peoria, IL (US)

(21) Appl. No.: 14/805,487

(22) Filed: Jul. 22, 2015

(51) Int. Cl. G06Q 10/06

(52) U.S. Cl. CPC G06Q 10/06315

(57) ABSTRACT

A computer implemented method for determining a safety stock volume for a part is disclosed. The computer implemented method includes receiving a first input, via a Graphical User Interface (GUI). The first input is indicative of one or more production parameters associated with the part. The method includes displaying the production parameters on the GUI in an editable format. The method also includes receiving a second input, via the GUI. The second input is indicative of one or more processing parameters in order to determine the safety stock of the part. The method also includes determining the safety stock volume based on the first input, the second input, and a timescale associated with the production parameters. The method further includes generating an output, via the GUI. The output is indicative of the safety stock volume for the part based on the first input, the second input, and the time scale.

### TECHNICAL FIELD

The present disclosure generally relates to a method for determining a safety stock for a part.

### BACKGROUND

Typically, inventory tracking and management systems are used for optimizing stock levels for a manufactured item. Low stock levels may have a detrimental effect on service level. If stock levels are too high, inventory costs associated with maintaining excess stock may be increased. Such inventory costs may include costs for larger storage space, higher insurance costs, etc. A balance between the high and low stock levels is an optimal safety stock. An optimum safety stock has to be maintained to lower such costs and to meet desired service level.

Many methods of determining the safety stock level exist to improve service level and inventory investment. For example, material requirement planning tools are used to determine the safety stock. Such tools determine safety stocks based on assumptions of constant demand throughout a period of time. The safety stock calculated thereby may be inaccurate.

For reference, U.S. Pat. No. 8,140,396 (the '396 patent) is related to a safety stock amount calculation method. The method includes calculating a probability Pb that a delivery time for a certain commodity required by a customer is shorter than its lead time L, calculating an average value LL of a difference between the lead time L and the customer's required delivery time when the lead time L exceeds the customer's required delivery time, correcting an inventory adjustment period N by using the average value LL, and calculating a safety stock amount SS by the equations SS=PB×k×(√N×F)×σ, wherein σ is a standard deviation of demand for the commodity, N is a corrected inventory adjustment period, Pb is a probability, F is a shipment frequency, and k is a safety coefficient. However, the method of the '396 patent may not be accurate in realistic scenarios.

### SUMMARY OF THE DISCLOSURE

In an aspect of the present disclosure, a computer implemented method for determining a safety stock volume for a part is disclosed. The computer implemented method includes receiving a first input, via a Graphical User Interface (GUI). The first input is indicative of one or more production parameters associated with the part. The method also includes displaying the one or more production parameters on the GUI in an editable format. The method also includes receiving a second input, via the GUI. The second input is indicative of one or more processing parameters in order to determine the safety stock of the part. The method also includes determining the safety stock volume based on the first input, the second input, and a timescale associated with the one or more production parameters. The method further includes generating an output, via the GUI. The output is indicative of the safety stock volume for the part based on the first input, the second input, and the time scale.

Other features and aspects of this disclosure will be apparent from the following description and the accompanying drawings.

### BRIEF DESCRIPTION OF THE DRAWINGS

FIG. 1 is a system for determining safety stock for a part, according to an embodiment of the present disclosure;

FIG. 2 is a Graphical User Interface (GUI) of the system displaying a process tab for importing a file, according to an embodiment of the present disclosure;

FIG. 3 is a GUI of the system displaying a process tab for production parameters, according to an embodiment of the present disclosure;

FIG. 4 is a GUI of the system displaying a process tab for other production parameters, according to an embodiment of the present disclosure;

FIG. 5 is a GUI of the system displaying a process tab for processing parameters, according to an embodiment of the present disclosure;

FIG. 6 is a GUI of the system displaying process tab for other processing parameters, according to an embodiment of the present disclosure;

FIG. 7 is a GUI of the system displaying an exemplary output, according to an embodiment of the present disclosure; and

FIG. 8 is a flowchart of a method for determining safety stock volume, according to an embodiment of the present disclosure.

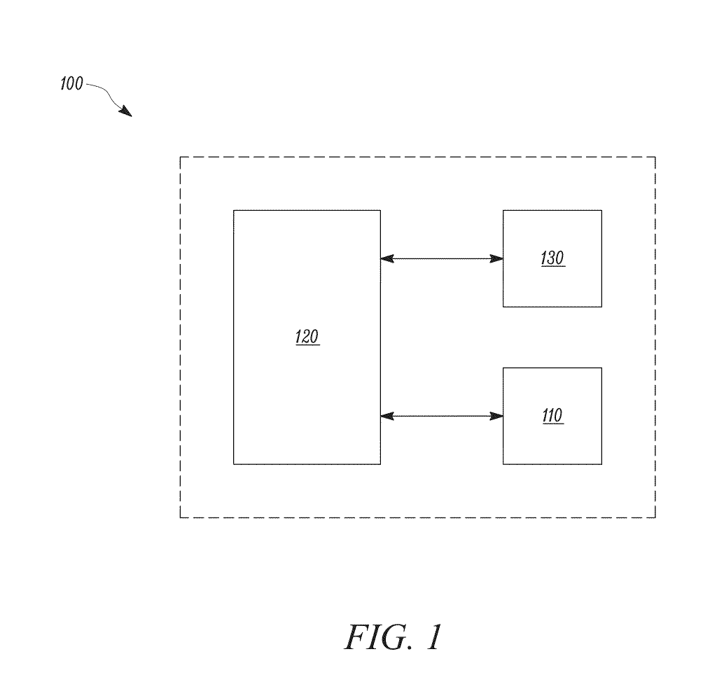

### DETAILED DESCRIPTION

Wherever possible, the same reference numbers will be used throughout the drawings to refer to same or like parts. FIG. 1 illustrates a block diagram of a system 100, according to an embodiment of the present disclosure. The system 100 may be employed to determine a safety stock volume for a part in an inventory environment. The inventory environment may include any type of inventory associated with monitoring and/or managing an inventory. For example, inventory environment may include an inventory warehouse configured to store one or more parts for operating a business. Further, the term “safety stock volume” refers to a number of parts in an inventory that is needed by a manufacturer to avoid running out of stock when the manufacturer encounters variations in inventory demand. The part, as the term used herein, may include any physical or virtual element that may be used as a product associated with a business. For example, the physical part may include a machine or machine parts such as engine, transmission, piston, and/or the like. Non limiting examples of virtual parts may include documentation, software, inventory data and/or the like.

The system 100 includes a Graphical User Interface (GUI) 110, a processing device 120 and a database 130. The GUI 110 may be at least one of a touch based interface, a keyboard based interface, a pointing device (e.g., a mouse) based interface, or a combination thereof.

The processing device 120 is disposed in communication with the GUI 110 and the database 130. The processing device 120 may receive one or more user inputs via the GUI 110. The processing device 120 may be any microprocessor based system, for example, a computer. The processing device 120 may be configured to execute instructions and provide one or more outputs based on the user inputs.

The database 130 is configured to store information associated with the inventory. For example, the database 130 may store inventory information associated with various parameters of inventory information. The inventory information may include a historical demand data, part number records, sales records, and the like. Moreover, various supply chain costs associated with making of a part may also be stored in the database 130. The supply chain costs may include a carrying cost, production cost, expedited cost, a transport cost, and the like. The database 130 may also store information related to one or more parts manufactured. The processing device 120 may be configured to lookup in the database 130 and retrieve data from the database 130. The database 130 may also be configured to receive output files from the processing device 120 and store the received files. In one embodiment, the database 130 may be an in-built memory that is integral with the processing device 120. In another embodiment, the database 130 may be external to the processing device 120.

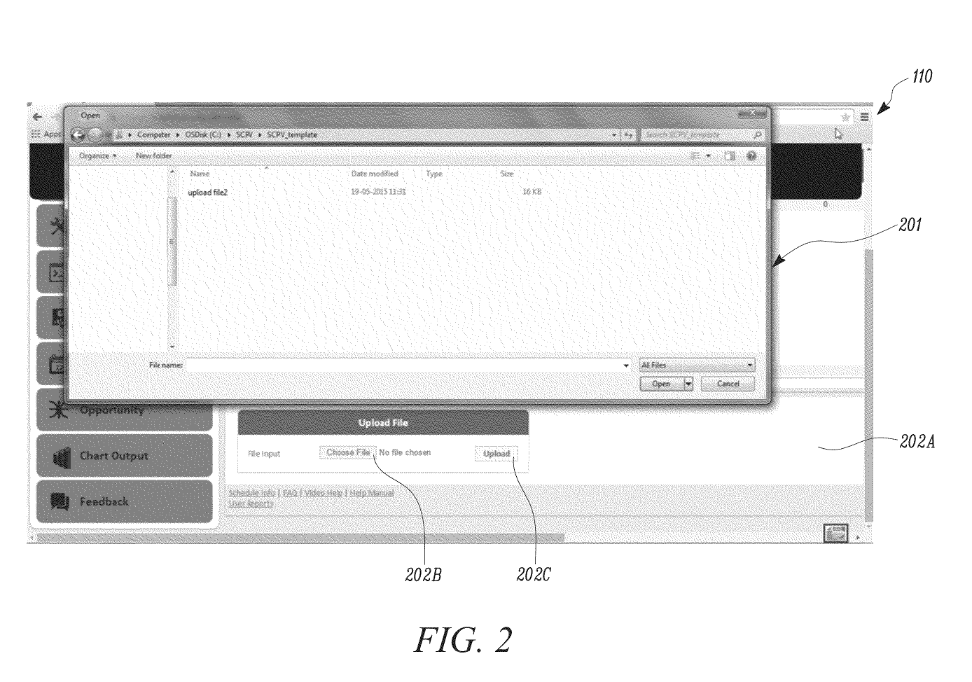

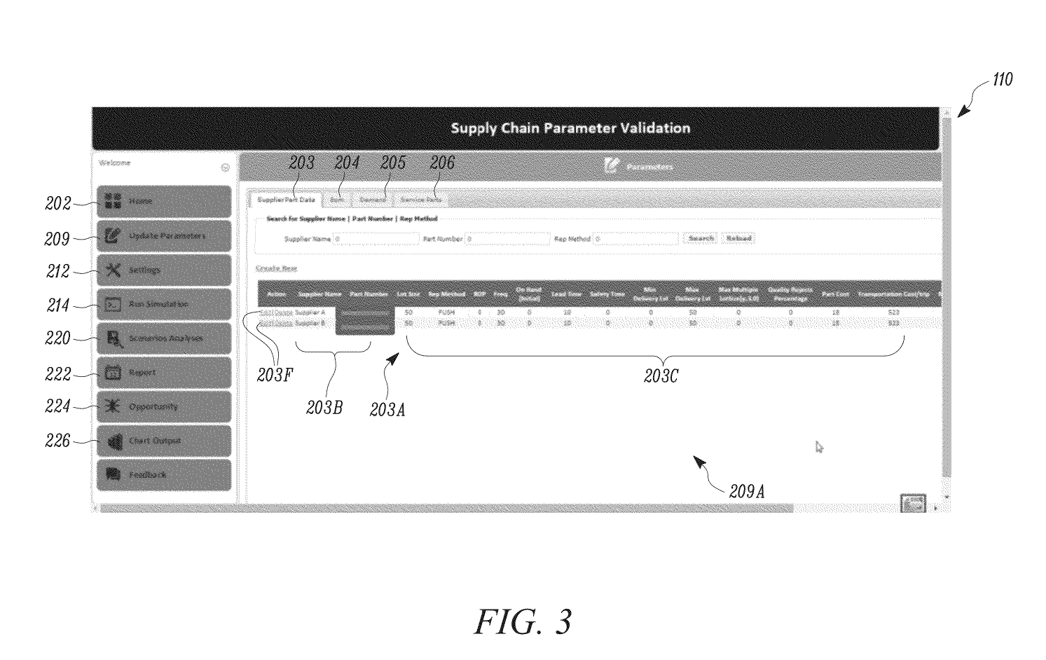

Referring to FIGS. 2 and 3, the GUI 110 includes multiple graphical control elements. Each of the graphical control elements allows a user to provide inputs related to various functions such as, but not limited to, selection of one or more features, creation of one or more files, and the like. The processing device 120 is configured to receive the user inputs via one or more of these graphical control elements and accordingly perform tasks. More specifically, the system 100 is configured to determine the safety stock volume based on user inputs received via the GUI 110.

The GUI 110 includes a control element 202 (shown in FIG. 3) that allows the user to provide input corresponding to selection of importing a file. In the illustrated embodiment, the control element 202 is a navigation button. The processing device 120 receives the input via the control element 202 and subsequently displays or navigates to a process tab 202A of the GUI 110. The process tab 202A may be, for example, a window, a dialogue box, a page, etc. The process tab 202A allows the user to provide input that is indicative of one or more production parameters associated with the part.

In the illustrated embodiment, the system 100 receives the input via importing a file from the database 130 into the system 100. The GUI 110 provides a path to import the input corresponding to the production parameters from the database 130. In an alternate embodiment, the GUI 110 may also provide a path to import the data from web tools such as email. Referring to FIG. 2, the process tab 202A includes a control element 202B that allows the user to choose a file stored in the database 130. In the illustrated embodiment, the control element 202B is a button. Upon clicking on the control element 202B, the processing device 120 receives instructions and consequently opens a window 201 displaying files stored in the database 130. Further, the process tab 202A of the GUI includes a control element 202C. The control element is a button that allows the user to upload the file containing the data corresponding to one or more production parameters associated with determination of the safety stock volume. In an embodiment, the file may be an excel spreadsheet. Upon uploading the file into the system 100, the GUI 110 displays the production parameters in the GUI 110.

The GUI 110 also includes a navigation button 209 that allows the user to provide input corresponding to selection of update parameter. Referring to FIG. 3, the processing device 120 displays or navigates to a process tab 209A. The process tab 209A displays the production parameters received via the imported file. Further, the process tab 209A also allows editing/deleting the production parameters via the control elements 203F. The process tab 209A includes control elements 203, 204, 205 and 206. The control element 203 allows the user to provide an input corresponding to supplier part data. The processing device 120 receives the input via the control element 203 and subsequently displays or navigates to a part data tab 203A. The control element 203 is a navigation button. The part data tab 203A allows user to input indicative of variables associated with the part data. The part data tab 203A includes control elements 203B, 203C, 203D, and 203E. The control elements 203B allows the user to input part details such as, part number, supplier name, etc. The control elements 203B may be input boxes, drop-down menus, list boxes and the like.

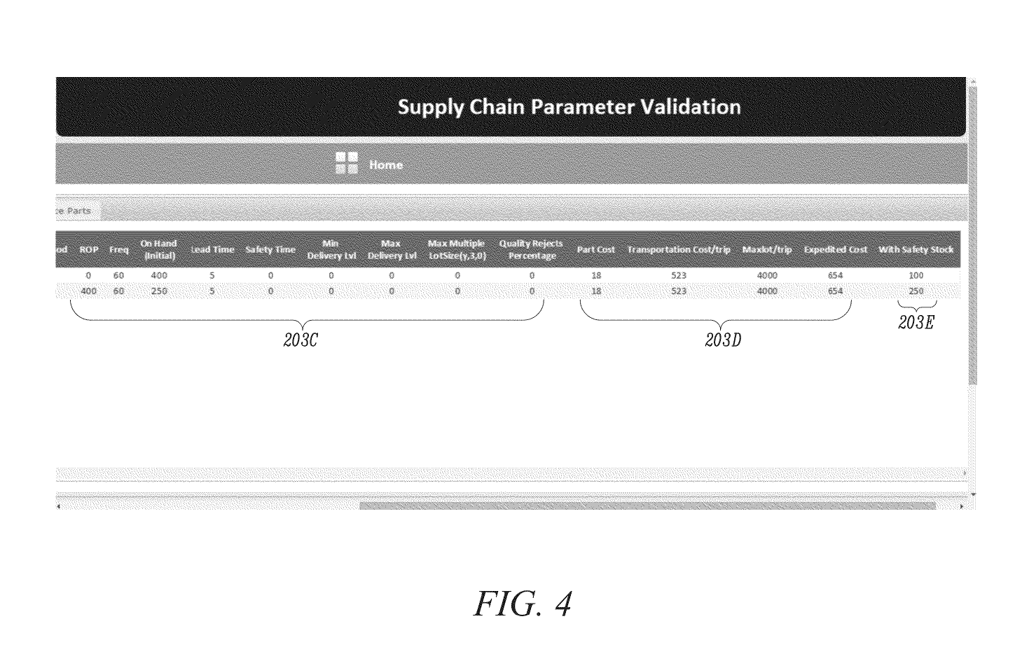

Referring to FIGS. 3 and 4, the control elements 203C allows the user to provide an input corresponding to manufacturing details. The manufacturing details may be lead time, replenishment method, lot size, reorder point (ROP), frequency, on hand inventory, lead time, safety time, maximum & minimum delivery level, and quality rejects percentage. The control elements 203C may be input boxes, drop-down menus, list boxes and the like. Further, the control elements 203D allow the user to provide an input corresponding to cost details associated with the part. The cost details include part cost, transportation cost, expedited cost, and max lot size per trip. The control elements 203D may be input boxes, drop-down menus, list boxes and the like. The process tab 203A also includes a control element 203E that allows the user to provide input corresponding to a safety stock value. The safety stock value may be determined using predicted inventory data. Alternatively, the safety stock value may be any random value to be used in case of safety stock validation.

The control element 204 allows user to provide an input corresponding to bill of material associated with the part. The processing device 120 receives the input via the control element 204 and subsequently displays or navigates to a Bill of Material (BOM) tab (now shown). The BOM tab may include control elements that may allow user to provide an input corresponding to bill of material details. The bill of material may be defined by a user based on an application. Accordingly, the bill of material may include a list of number of materials, parts, components, subcomponents and the like. For example, the bill of material may include a list of subcomponents to assemble/manufacture a part

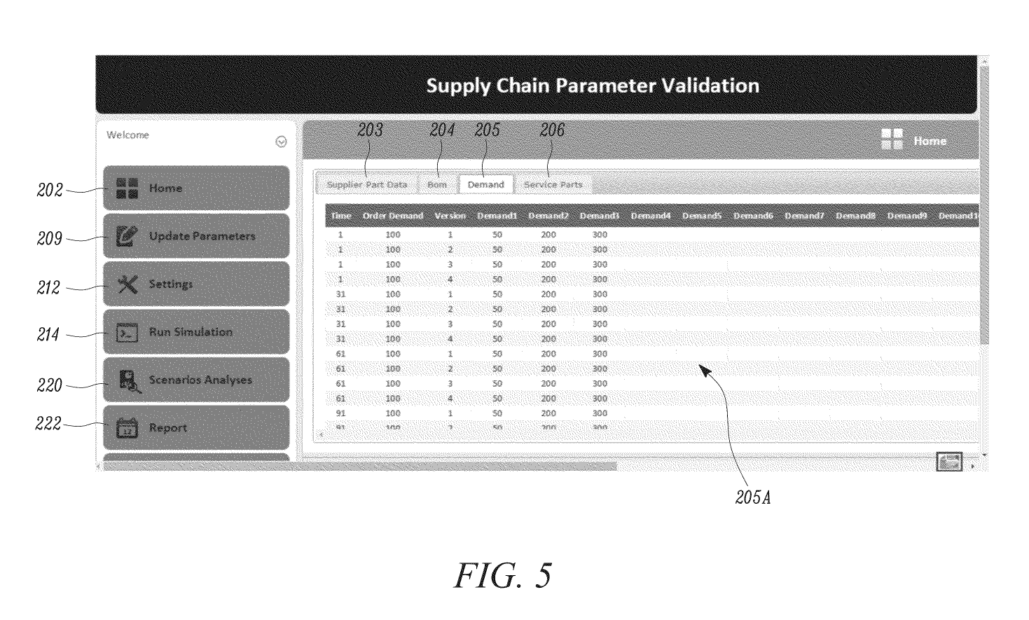

The control element 205 allows user to provide an input corresponding to demand profile associated with the part. As shown in FIG. 5, the processing device 120 receives the input via the control element 205 and subsequently displays or navigates to a demand profile tab 205A. The process tab 205A includes multiple control elements that allows user to provide an input corresponding to a timescale associated with the demand profile. The demand profile tab also includes multiple control elements that may allow that user to provide an input associated with demand profile corresponding to the timescale. The term “demand profile” refers to a quantity of inventory parts in an inventory order from a customer at particular time.

The control element 206 may allow user to provide an input corresponding to service parts. The processing device 120 may receive the input via the control element 206 and subsequently display or navigate to a service parts tab (now shown). The service parts tab parts may include a tabular data representing a quantity of part to be manufactured with respect to the timescale.

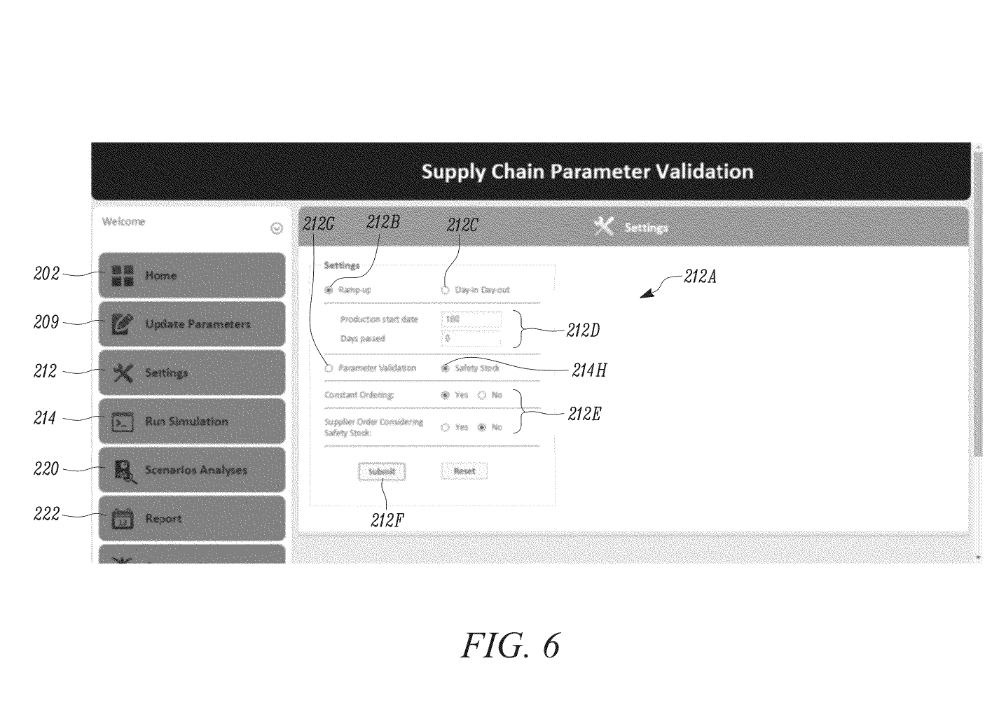

In the illustrated embodiment, the GUI 110 also includes a control element 212 that may allow the user to provide input corresponding to selection of processing parameters. As shown in FIG. 6, upon clicking on the control element 212, the processing device 120 may display or navigate to a process tab 212A of the GUI 110. The process tab 212A may be, for example, a window, a dialogue box, a page, etc. The process tab 212A includes radio buttons 212B, 212C that may allow user to select analysis parameters associated with determination of safety stock volume. Upon selecting any of the radio buttons 212B, 212C, the processing device 120 may receive the instructions associated with ramp-up analysis. Further, upon selecting the radio button 212C, the processing device 120 may receive the instructions associated with Day-in Day-out analysis.

The process tab 212A includes control elements 212D that may allow the user to provide input associated with production planning parameters. The production planning parameters includes production start date and number of days passed. The control elements 212D may be input boxes, drop-down menus, list boxes and the like. The process tab 212A also includes radio buttons 212E that may allow the user to select ordering parameters. The ordering parameters include constant ordering and supplier order considering safety stock. The process tab 212A also includes radio buttons 212G, 212H. The radio buttons 212G, 212H allows the user to select a type of analysis, for example, calculating safety stock or parameter validation. The process tab 212A includes a submit button 212F. Upon clicking the submit button 212F, the processing device 120 may store the processing parameters associated with the determination of the safety stock in the database 130.

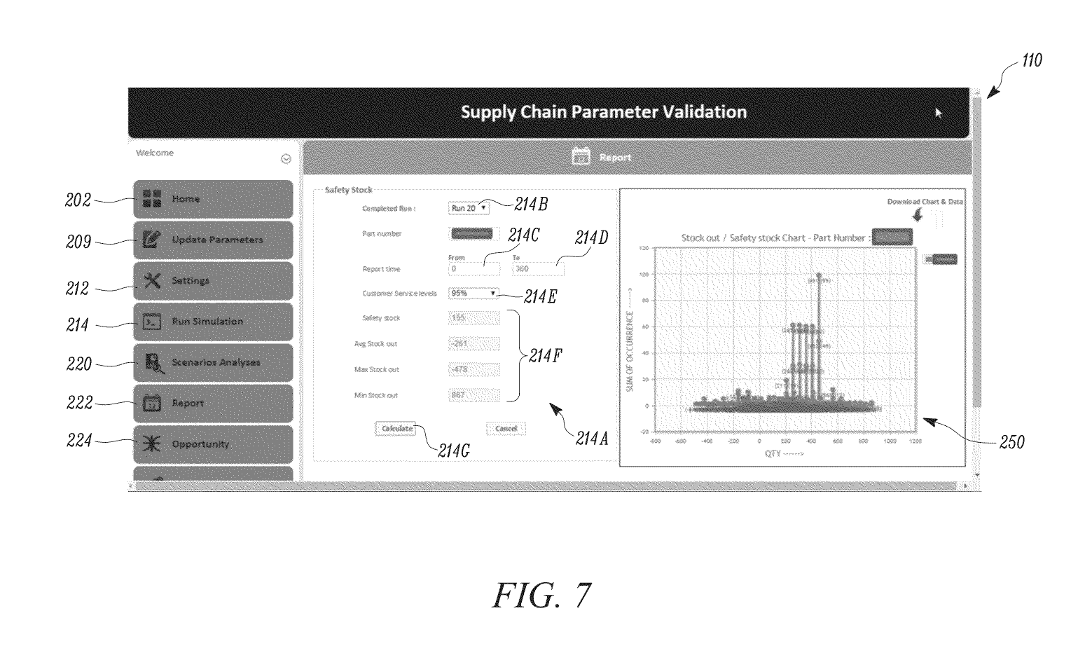

The GUI 110 also includes a control element 214 that may allow the user to provide input corresponding to other processing parameters. The control element 214 may be a navigation button. Referring to FIG. 7, the processing device 120 displays a process tab 214A as the user clicks on the control element 214. The process tab 214A includes a control element 214B that may allow user to select a run. The run may correspond to a value that indicates a particular analysis. In the illustrated embodiment, the control element 214B is drop-down menu listing different runs. Upon selecting a run number, the processing device 120 may retrieve a file from the database 130 corresponding to a particular set of parameters for a particular run. The process tab 214A also includes control elements 214C, 214D that allows the user to provide input corresponding to report time. In the illustrated embodiment, the control elements 214C, 214D are input boxes that allow the user to enter a start time and an end time of the production for a particular analysis. The process tab 214A also includes a control element 214E that may allow the user to provide input corresponding to customer service level. The customer service may indicate a percentage of demand for a part that the user in planning to meet. In the illustrated embodiment, the control element 214E is a drop down menu that allows the user to select a numeric value between 0 and 100 indicative of customer service level.

The process tab 214A includes a calculation button 214G that may allow the user to give instruction to calculate the safety stock volume associated with processing parameters, production parameters and the timescale. The processing device 120 may receive the instruction via the calculation button 214G and determines the safety stock volume. Specifically, the processing device 120 determines the safety stock volume based on the production parameters, the processing parameters and the timescale received via various control elements of the GUI 110. Moreover, the processing device 120 determines the safety stock volume and auto-fill the determined safety stock volume for display to the user via the control elements 214F. The processing device 120 also determines an average safety stock volume, maximum safety stock volume, and minimum safety stock volume over the timescale and auto-fills the determined corresponding values.

Further, the processing device 120 is configured to generate an output 250 based on the safety stock volume determined. Referring to FIGS. 6 and 7, the output 250 is represented as a plot of safety stock for a part against a sum of occurrences. Further, the processing device 120 may save the outputs 250 in a file in the database 130 based on a user input received via one or more control elements of the GUI 110.

Moreover, the processing device 120 is also configured to generate an output indicative of a safety stock volume for a part in different scenarios. Referring to FIG. 6, the GUI 110 includes control element 220 that may allow the user to provide input corresponding to selection of a scenario. In an embodiment, the control element 220 may allow the user to select the scenario from multiple scenarios in the database 130. In an alternate embodiment, the control element 220 may allow the user to production and processing parameters. Moreover, each scenario may be associated with each parameter. As such, an output parameter for a particular scenario may be stored in the data base 130 via one or more control elements of the GUI 110. Moreover, the GUI 110 may also display an output corresponding to each scenario.

The processing device 120 is also configured to receive input corresponding to a selection of report, via the control element 222 and generate an output based on the selected report format and the selected scenario. Further, the GUI 110 includes control elements 224. The processing device 120 may receive an input corresponding to a selection of a part via the control element 224 and generated an output for a corresponding selected part. The GUI 110 also includes a control element 226 that may allow the user to provide input corresponding to a selection of chart format. The processing device 120 may receive an input corresponding to a selection of chart type and generate an output based on the selected chart type. For example, the processing device 120 may generate an output that includes an inventory profile for a period of time in a table, graphical and a pie-chart representation. Various other outputs may also be generated based on a selection of chart and report type via the control elements 222 to 226. The processing device 120 may also generate an output that includes various cost details associated with the safety stock volume. The cost details may include transportation cost, expedited cost, carrying cost and the like. Moreover, the processing device 120 may also be configured to lookup the database 130 and retrieve one or more files. Further, the processing device 120 may also be configured to display the safety stock volume associated with the retrieved files via the GUI 110. The processing device 120 may also be configured to compare the safety stock volume associated with the retrieved files and generate an output thereafter.

A person of ordinary skill in the art will acknowledge that the GUI 110 and the corresponding graphical control elements explained above are merely exemplary in nature and hence non-limiting of this disclosure. Moreover, necessary design and/or functional modifications may be possible for the GUI 110 without deviating from the scope of the present disclosure.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

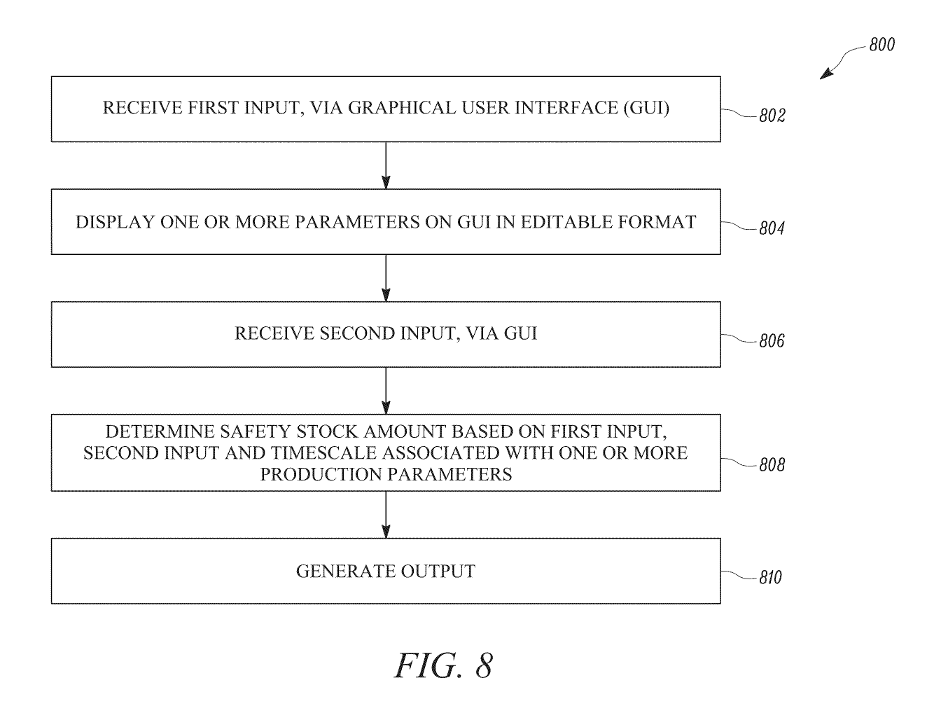

FIG. 8 illustrates a flowchart of a computer-implemented method 800 for determining a safety stock volume for a part, according to an embodiment of the preset disclosure. In an embodiment, the method 800 may be implemented via the system 100 described above.

At step 802, the method 800 includes receiving a first input, via the GUI 110. The first input is indicative of one or more production parameters associated with the part. In the illustrated embodiment, the control element 202 allows the user to provide input corresponding to selection of production parameters. Further, the process tab 202A of the GUI 110 allows the user to input various production parameters. The production parameters include part data, bill of material, demand profile and the service parts information. The GUI 110 allows the user to upload a file containing the production parameters from the database 130.

At step 804, the method 800 includes displaying the one or more parameters on the GUI in an editable format. In the illustrated embodiment, the control element 202B allows the user to edit the production parameters displayed in the process tab 209A of the GUI 110. Further, the processing device 120 is configured to receive updated parameters via the various control elements in the process tab 209A.

At step 806, the method 800 includes receiving a second input, via the GUI 110. The second input is indicative of one or more processing parameters in order to determine the safety stock of the part. In the illustrated embodiment, the processing device 120 displays or navigates to a process tabs 212A, 214A associated with the processing parameters upon receiving the instruction via the navigation buttons 212, 214. Referring to FIGS. 6 and 7, the control elements of the process tabs 212A, 214A allows the user to provide an input that is indicative of the processing parameters.

At step 808, the method 800 includes determining the safety stock volume based on the first input, the second input and a timescale associated with the one or more production parameters. In the illustrated embodiment, the processing device 120 determines the safety stock volume based on the first input, the second input and the timescale associated with the production parameters. Specifically, the processing device 120 determines the safety stock volume based on the inputs indicative of production parameters, processing parameters and the timescale received via the various control elements of the process tabs 209A, 212A and 214A. In an embodiment, the safety stock volume may be determined based on discrete event modelling.

At step 810, the method 800 includes generating an output, via the GUI. The output is indicative of the safety stock volume for the part based on the first input, the second input and the timescale. The processing device 120 generates the output 250 (shown in FIG. 7) via the GUI 110, indicative of the safety stock volume associated with the processing parameters, the production parameters and the timescale.

The method 800 of the present disclosure has applicability for use and implementation in determining a safety stock volume for a part. With such implementation, a safety stock volume may be determined by taking into account various parameters, thereby accurately determining the safety stock volume. As the method 800 uses a timescale associated with the production parameters, a real time tracking of inventory may be obtained. Additionally, with use of the method 800, output may also be generated according to various scenarios. The method 800 may also allow saving a file including the various parameter costs within the database 130 such that the file may be retrieved and modified later. Further, the system 100 and the method 800 may also be implemented to validate one or more parameters associated with an inventory environment. For example, the processing device 120 may receive instruction via the radio button 214G, to validate a safety stock volume provided by the user via the control element 203E of the process tab 209A. Similarly, various other parameters may also be validated by providing such parameters via the control elements of process tab 209A. Hence, an optimum inventory management may be obtained based on various outputs.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A computer implemented method for determining a safety stock volume for a part, the computer implemented method comprising:
receiving a first input, via a Graphical User Interface (GUI), wherein the first input being indicative of one or more production parameters associated with the part;
displaying the one or more parameters on the GUI in an editable format;
receiving a second input, via the GUI, wherein the second input being indicative of one or more processing parameters in order to determine the safety stock of the part;
determining the safety stock volume based on the first input, the second input and a timescale associated with the one or more production parameters; and
generating an output, via the GUI, wherein the output being indicative of the safety stock volume for the part based on the first input, the second input and the time scale.
